(19) United States
(12) Patent Application Publication
(10) Pub. No.: US 2010/0255210 A1
(43) Pub. Date: Oct. 7, 2010

(54) PROCESS FOR FINISHING TEXTILES

(75) Inventors: Jüergen Falkowski, Monheim (DE); Raymond Mathis, Dusseldorf (DE); Robert Schütz, Tonisvorst (DE)

Correspondence Address: FOX ROTHSCHILD LLP, 997 Lenox Drive, Bldg. #3, Lawrenceville, NJ, 08648, US

(73) Assignee: COGNIS IP MANAGEMENT GMBH, DUESSELDORF (DE)

(21) Appl. No.: 12/095,521

(22) PCT Filed: Nov. 21, 2006
(86) PCT No.: PCT/EP06/11119

§ 371 Date: May 30, 2008

(30) Foreign Application Priority Data
Nov. 30, 2005 (DE) 10-2005-056-967.6

(51) Int. Cl. B05D 1/02

(52) U.S. Cl. 427/427.4

(57) ABSTRACT

A process for finishing textiles, including spraying, onto a textile, an aqueous microcapsule dispersion, including water; microcapsules; one or more polymeric dispersants; and one or more anionic wetting agents, where the wetting agents are different from the one or more polymeric dispersants is provided.

### CROSS-REFERENCE TO RELATED APPLICATIONS

This application is the national phase under 35 U.S.C. §371 of PCT International Application No. PCT/EP2006/011119, which has an International filing date of Nov. 21, 2006, which designated the United States of America and which claims priority from German Patent Application number DE 10 2005 056967.6, filed Nov. 30, 2005, the entire contents of each of which are hereby incorporated herein by reference.

### BACKGROUND OF THE INVENTION

1. Field of the Invention

This invention relates generally to aqueous microcapsule dispersions, and more particularly, to aqueous microcapsule dispersions for finishing textiles.

2. Background Information

Microcapsules containing various ingredients are being increasingly used for finishing textiles. The function of the microcapsules is to delay the release of their active components on the surface of the textile in order, for example, to obtain cosmetic effects on the skin. Microcapsules with the corresponding ingredients can be produced by various methods. A summary of these methods can be found, for example, in the following literature reference: K. Lacasse, W. Baumann; Textile Chemicals, Table 6-22, Berlin 2004. The microcapsules obtained by these methods typically have a diameter of 1 to 10 μm. For finishing textiles with these microcapsules, the microcapsules are normally used in the form of an aqueous dispersion which is further diluted in the textile liquor. These aqueous solutions may then be used, for example in a padding or absorption process for finishing textiles. Absorption processes are preferably used in textile-processing factories, above all for the finishing of textile fabrics or made-up textiles produced completely or partly from modern synthetic fibers, such as for example, polyester, polyamide or elastane. The exhaust method for applying microcapsules has the disadvantage that the microcapsules not absorbed by the textile are lost, which can make finishing uneconomical in view of high production costs and expensive ingredients. In addition, there is the danger that the microcapsules can be unevenly absorbed so that unsightly stains or agglomerates are left behind on the textiles.

It has also been proposed to cationize microcapsules through the use of auxiliaries so that they can be better absorbed by negatively charged surfaces. However, such processes require additional chemicals or additional treatment steps. In many cases, agglomerates still remain behind on the textiles because both the microcapsules and the textiles to be treated carry different charges and the auxiliaries used or the necessary process conditions have to be re-adapted for each finishing cycle.

### SUMMARY OF THE INVENTION

Briefly described, according to an aspect of the invention, a process for finishing textiles, includes spraying, onto a textile, an aqueous microcapsule dispersion, including water; microcapsules; one or more polymeric dispersants; and one or more anionic wetting agents, where the wetting agents are different from the one or more polymeric dispersants.

### DETAILED DESCRIPTION OF THE INVENTION

The problem addressed by the present invention was to provide a process by which microcapsules could be applied to textiles without losses or staining. This problem is excellently solved in every respect by the process according to the invention.

The present invention relates to a process for finishing textiles with microcapsules in which aqueous microcapsule dispersions containing
a) water,
b) microcapsules,
c) one or more polymeric dispersants and
n) one or more anionic wetting agents, the wetting agents being different from the polymeric dispersants,
   are applied to textiles, characterized in that the aqueous microcapsule dispersion is applied to the textile by spraying.

It is expressly emphasized that it is not obvious for an aqueous composition to be sprayable or to leave behind no residues or stains when sprayed in uniform distribution onto textiles. In their own investigations, applicants discovered the following: if an aqueous microcapsule dispersion consisting of components a) and b) mentioned above is diluted with water to a viscosity of ca. 10 to 50 mPas, which is particularly suitable for spraying, and if such a dispersion is sprayed onto a textile, visible droplets are formed on the textile, and subsequently dry to form relatively large and visible agglomerates.

The addition of additional conventional nonionic, anionic or cationic emulsifiers to such microcapsule dispersions does not produce any improvement in the appearance of the textile. In addition, such emulsifiers may cause softening of the polymeric capsule shell of the microcapsules so that the ingredients may be released prematurely and not as intended.

Only when all the above-mentioned features of the present invention are observed is the stated problem successfully solved. To this end, the aqueous microcapsule dispersion must contain not only the above-mentioned components a) and b), but also c) and n), and must be applied by spraying.

In addition, it is emphasized that the dispersions containing components a), b), c) and d) are stable in storage for prolonged periods. The polymeric capsule shell of the microcapsules is not damaged or softened by the compounds c). The absorption behavior of the microcapsules on textiles is not impaired by the compounds c), nor are any deposits formed on the rollers used in the application of the microcapsules to the textiles.

The aqueous microcapsule dispersions to be used in the process according to the invention may optionally contain viscosity adjusters d), with the proviso that the compounds d) must be chemically different from the compounds c) and the compounds n). If desired, the microcapsule dispersions may also contain other additives typically used in the finishing of textiles.

### Microcapsules b)

In the context of the present invention, microcapsules are basically understood to be organic polymers with a certain three-dimensional structure (cf.: K. Lacasse and W. Baumann, Textile Chemicals, Environmental Data and Facts, Berlin 2004, pages 468-482). So far as their three-dimensional structure is concerned, the microcapsules are hollow microspheres which typically have a diameter of 2 to 2,000 μm and an external diameter of 0.1 to 200 μm and, more particularly, 0.5 to 150 μm. Because they are hollow, the microcapsules can be charged with ingredients or active components.

Charged microcapsules, i.e., microcapsules charged with one or more ingredients or active components, are always used for the purposes of the present invention. In principle, the ingredients or active components may be any substances which are intended to be passed onto the skin during the wearing of the textile finished with the charged microcapsules (through contacting of the textile with the microcapsule dispersions according to the invention). Such substances include, for example, fats, oils, plant extracts, vitamins, perfumes, repellents, insecticides and the like. Preferred oils are vegetable oils with skin-care and health-promoting properties, for example, coconut oil, passion flower oil, shea butter, rose hip seed oil, lavender oil, and apricot kernel oil. Preferred plant extracts are rhodysterol and aloe vera. Of particular importance for the purposes of the invention are active components or ingredients which have skin-care, moisturizing, stimulating, soothing, cellulitis-reducing, skin-firming, repellent and refreshing properties.

The encapsulated substances—hereinafter also referred to as the core material—may consist of any solid, liquid or gaseous materials which are to be incorporated in corresponding products in encapsulated form. Perfumes, such as perfume oils, or substances with a care effect in the intended field of application are preferably used as the core materials.

Individual perfume compounds may be used as perfume oils or perfumes and include, for example, synthetic products of the ester, ether, aldehyde, ketone, alcohol and hydrocarbon type. Examples of perfume compounds of the ester type are benzyl acetate, phenoxyethyl isobutyrate, p-tert.butyl cyclohexylacetate, linalyl acetate, dimethyl benzyl carbinyl acetate, phenyl ethyl acetate, linalyl benzoate, benzyl formate, ethylmethyl phenyl glycinate, allyl cyclohexyl propionate, styrallyl propionate and benzyl salicylate. Ethers include, for example, benzyl ethyl ether while aldehydes include, for example, the linear alkanals containing 8 to 18 carbon atoms, citral (geraniol), citronellal, citronellyloxyacetaldehyde, cyclamen aldehyde, hydroxycitronellal, lilial and bourgeonal. Examples of suitable ketones are the ionones, α-isomethylionone and methyl cedryl ketone. Suitable alcohols are anethol, citronellol, eugenol, isoeugenol, geraniol, linalool, phenylethyl alcohol and terpineol. The hydrocarbons mainly include the terpenes, such as limonene and α-pinene. Eucalyptol (1,8-cineol) may also be used as a perfume. However, it is preferred to use mixtures of different perfume compounds which, together, produce an agreeable fragrance. Such perfume oils may also contain natural perfume mixtures which are obtainable from vegetable sources, for example, pine, citrus, jasmine, patchouli, rose or ylang-ylang oil. Other suitable perfume oils are sage oil, camomile oil, clove oil, melissa oil, mint oil, eucalyptus oil, cinnamon leaf oil, lime-blossom oil, juniper berry oil, vetiver oil, olibanum oil, galbanum oil and ladanum oil and orange blossom oil, neroli oil, orange peel oil and sandalwood oil. Other suitable perfumes are nitriles, sulfides, oximes, acetals, ketals, acids, Schiff's bases, heterocyclic nitrogen compounds, such as indole and quinoline, pyrazines, amines, such as anthanilates, amides, organohalogen compounds, such as rose acetate, nitrated compounds, such as nitromusk, heterocyclic sulfur compounds, such as thiazoles, and heterocyclic oxygen compounds, such as epoxides, which are all known to the expert as possible perfumes.

Examples of care components are vitamins and provitamins, such as vitamin A, vitamin C, vitamin E (α-tocopherol), vitamin F (polyene fatty acids), panthenol (provitamin B5), β-carotene (provitamin A) and derivatives thereof (for example, esters, such as stearyl ascorbate), plant extracts, biopolymers, antidandruff agents, UV protection factors, emollients (cosmetic oils), and silicone oils.

For cosmetic applications, preferred care components are tocopherols and lipid-soluble derivatives thereof. Suitable tocopherols are for example, the natural tocopherols and mixtures thereof and synthetic tocopherols. Suitable derivatives are, for example, tocopheryl acetate, tocopherol nicotinate, tocopheryl ascorbate, tocopheryl retinoate, tocopheryl succinate, tocopheryl linoleate or tocopheryl benzoate.

### Compounds c)

As already mentioned, the compounds c) are polymeric dispersants, i.e., compounds which, structurally, may be regarded as polymers and which have a dispersing and/or emulsifying effect on the microcapsules b). The polymers c) may be homopolymers or copolymers and must consist of at least five monomer units.

In a preferred embodiment, homopolymers are used as the compounds c).

In another preferred embodiment, polymers c) with molecular weights of at least 500 are used as the compounds c).

The monomer units on which the polymeric dispersants c) are based may originate from natural raw material sources or may be of synthetic origin. Examples of polymeric dispersants c) of which the monomer units are of natural origin are polymers based on cellulose (for example, sodium carboxymethyl cellulose) or polysaccharides (for example, xanthan gum, gellan gum, guar or pectins).

Examples of polymeric dispersants c) of which the monomer units are of synthetic origin are acrylates (for example, sodium polyacrylates), methacrylates or alkyl acrylates (for example, pemulen).

If desired, the monomer units of which the dispersants c) are made up may also be chemically modified.

In a most particularly preferred embodiment, compounds selected from the group consisting of xanthan gum, gellan gum, guar, polyacrylates are used as the polymeric dispersants c). These dispersants may be used individually or in admixture with one another.

### Anionic Wetting Agents n)

As already mentioned, the anionic wetting agents must be different from the polymeric dispersants c). They must also be different from the viscosity adjusters d).

Examples of suitable anionic wetting agents n) are alkyl sulfates (for example, Sulfopons from Cognis), alkyl and dialkyl sulfosuccinates (for example, DISPONIL® SUS products from Cognis), alkyl sulfosuccinamates, alkyl sulfosuccinamides, alkyl sulfosuccinimides or mixtures of compounds belonging to these classes. The alkyl chain of the product classes mentioned preferably contains 6 to 24 carbon atoms; if desired, the compounds may be ethoxylated or propoxylated. As known to the expert, ethoxylated alkyl sulfates are alkyl ether sulfates (for example, TEXAPON® products from Cognis). The degree of ethoxylation in the case of the alkyl ether sulfates is preferably between 1 and 50 and, more particularly, in the range from 2 to 10.

### Viscosity Adjusters d)

The viscosity adjusters must be different from the anionic wetting agents n). They must also be different from the polymeric dispersants c). The viscosity adjusters d) may be, for example, organic or inorganic salts. For example, alkali metal salts or alkaline earth metal salts, including sodium chloride or magnesium chloride, may be used. Suitable organic salts are, for example, urea, urea derivatives or amino acids. Inorganic salts are preferred viscosity adjusters d).

### Microcapsule Dispersions

The microcapsule dispersions according to the invention preferably have a capsule concentration of 1 to 50% by weight. The concentration of microcapsules is preferably in the range from 1 to 20% by weight. The percentages by weight mentioned represent % by weight of microcapsules b), based on the dispersion as a whole.

The microcapsules may have a diameter of 0.1 to 200 μm, the preferred range being 1 to 20 μm.

The microcapsules charged with one or more active components and/or ingredients may be produced by any of the methods known to the relevant expert. A summary of corresponding methods can be found, for example, in the following literature reference: K. Lacasse, W. Baumann; Textile Chemicals, Table 6-22, Berlin 2004.

Basically, there are no particular limits to the quantity in which the polymeric dispersants c) to be used in accordance with the invention are present in the aqueous microcapsule dispersions. However, the polymeric dispersants c) are preferably used in quantities of 0.05 to 2% by weight, and more particularly in quantities of 0.1 to 1% by weight. The percentages by weight mentioned represent % by weight of dispersants c), based on the dispersion as a whole.

The polymeric dispersants c) may be directly introduced into an aqueous dispersion of the microcapsules b) and dissolved therein, the temperature optionally being slightly elevated, preferably to a value in the range from 20 to 80° C. The use of dispersing machines, for example, toothed dispersing machines or high-pressure homogenizers, may be desirable, but is not generally necessary, and is preferably avoided in order to prevent unwanted damage to the microcapsules before or during application to the textile, which could even result in unwanted premature release of the active components present.

The present invention also relates to the use of aqueous microcapsule dispersions containing:
(a) water,
(b) microcapsules,
(c) one or more polymeric dispersants and
(n) one or more anionic wetting agents, the wetting agents being different from the polymeric dispersants,
   for finishing textiles, the finishing process being carried out by spraying.

In one embodiment, the dispersions contain viscosity adjusters d) as an additional component, with the proviso that the compounds d) are different from the compounds c) and the compounds n).

In one embodiment, inorganic salts are used as the viscosity adjusters d).

In another embodiment, compounds selected from the group consisting of xanthan gum, gellan gum, guar and polyacrylates are used as the polymeric dispersants c).

### EXAMPLES

### Example 1 (Invention)

200 grams of a microcapsule dispersion, of which 30% by weight consisted of about 2-5 μm large capsules with oil-containing care ingredients and 70% of water, were mixed with 800 grams of deionized water and 2 grams of a dialkyl sulfosuccinate (DISPONIL® SUS IC 875 from Cognis) and heated to 70° C. 1.5 grams of an Na polyacrylate (COSMEDIA® SP from Cognis) were then added, followed by brief stirring until all solid particles had dissolved. The dispersion formed had a viscosity of 40 mPas and was sprayed from a commercially available pump spray bottle onto a black textile fabric. The quantity of dispersion applied by spraying amounted to 20% by weight, based on the weight of the fabric. After drying of the fabric at room temperature, there were no visible stains (for example, in the form of microcapsule agglomerates). The dispersion remained stable in storage, did not thicken (no increase in viscosity during storage) and could still be sprayed without any residues after storage for several months.

### Example 2 (Comparison)

No wetting agent was used in this Example.

200 grams of a microcapsule dispersion, of which 30% by weight consisted of about 2-5 μm large capsules with oil-containing care ingredients and 70% of water, were mixed with 800 grams of deionized water and heated to 70° C. 1.5 grams of an Na polyacrylate (COSMEDIA® SP from Cognis) were then added, followed by brief stirring until all solid particles had dissolved. The dispersion formed had a viscosity of 35 mPas and was sprayed from a commercially available pump spray bottle onto a black textile fabric. Relatively large droplets were actually visible on the fabric during spraying. After drying, white stains of microcapsule agglomerates were clearly visible on the fabric.

What is claimed is:

1-11. (canceled)

12. A process for finishing textiles, comprising spraying, onto a textile, an aqueous microcapsule dispersion, comprising:
(a) water;
(b) microcapsules;
(c) one or more polymeric dispersants; and
(n) one or more anionic wetting agents, wherein the wetting agents are different from the one or more polymeric dispersants.

13. The process according to claim 12, wherein the aqueous microcapsule dispersion further comprises one or more viscosity adjusters d), wherein the viscosity adjusters d) are different from the one or more polymeric dispersants c) and the one or more wetting agents n).

14. The process acccording to claim 12, wherein the one or more polymeric dispersants are homopolymers.

15. The process according to claim 12, wherein the one or more polymeric dispersants are copolymers.

16. The process according to claim 12, wherein the one or more polymeric dispersants are selected from the group consisting of xanthan gum, gellan gum, guar and polyacrylates.

17. The process according to claim 12, wherein the one or more anionic wetting agents n) are selected from the group consisting of alkyl sulfates, alkyl and/or dialkyl sulfosuccinates, alkyl sulfosuccinamates, alkyl sulfosuccinamides, alkyl sulfosuccinimides, and mixtures thereof.

18. The process according to claim 12, wherein the one or more anionic wetting agents n) are selected from the group consisting of ethoxylated and/or propoxylated alkyl sulfates, ethoxylated and/or propoxylated alkyl and/or dialkyl sulfosuccinates, ethoxylated and/or propoxylated alkyl sulfosuccinamates, ethoxylated and/or propoxylated alkyl sulfosuccinamides, ethoxylated and/or propoxylated alkyl sulfosuccinimides, and mixtures thereof.

19. The process according to claim 13, wherein the one or more viscosity adjusters d) are inorganic salts.
